(19) United States
(12) Patent Application Publication
(10) Pub. No.: US 2011/0015348 A1
(43) Pub. Date: Jan. 20, 2011

(54) BLEND OF POLYESTER AND POLYCARBONATE HAVING TRANSPARENCY AND HEAT RESISTANCE

(76) Inventors: Jeong-Jun Hwang, Gyeonggi-do (KR); Dong-June Hwang, Incheon (KR); Tae-Young Kim, Gyeonggi-do (KR); Jae-Bong Lim, Gyeonggi-do (KR)

Correspondence Address: BIRCH STEWART KOLASCH & BIRCH, PO BOX 747, FALLS CHURCH, VA, 22040-0747, US

(21) Appl. No.: 12/667,499

(22) PCT Filed: Jul. 3, 2008
(86) PCT No.: PCT/KR08/03940

§ 371 Date: Dec. 31, 2009

(30) Foreign Application Priority Data
Jul. 4, 2007 (KR) 10-2007-0067216

(51) Int. Cl. C08L 69/00

(52) U.S. Cl. 525/185

(57) ABSTRACT

A polyester/polycarbonate blend having superior transparency and heat resistance which is useful for producing transparent polyester articles is disclosed. The blend of polyester and polycarbonate includes (a) polyethyleneterephthalate (PET) prepared with terephthalic acid component and ethylene glycol component, or copolymerized polyethyleneterephthalate prepared with terephthalic acid component and ethylene glycol component, and further copolymerized with 1 to 10 mol % of isophthalic acid, cyclohexane dimethanol (CHDM), di-ethylene glycol and/or alkylene glycol of 3 to 6 carbon atoms component with respect to acid or diol components; (b) polycarbonate (PC); and (c) CHDM modified PET prepared with 20 to 80 mol % CHDM with respect to diol components, wherein the amount of the PC is 10 to 60 wt % with respect to the mixture of (a) PET and (b) PC, and the amount of the (c) CHDM modified PET is 0.2 to 2.5 times by weight with respect to the amount of (b) PC.

### TECHNICAL FIELD

This application claims the priority benefit of Korean Patent Application No. 10-2007-0067216 filed on Jul. 4, 2007, the entire contents of which are incorporated herein by reference. This invention relates to a polyester/polycarbonate blend, and more particularly to a polyester/polycarbonate blend having superior transparency and heat resistance which is useful for producing transparent polyester articles.

### BACKGROUND ART

Polyester resin, such as polyethylene terephthalate (hereinafter, PET), has superior transparency and more preferable properties for a human body and an environment compared with other synthetic resins. Thus, the polyester resin is conventionally used for the production of a food packaging material, such as drink bottle. Recently, as a new use of the polyester resin, the polyester resin is molded into a thick plastic sheet, and the produced sheet is used for the production of an interior decoration board, a signboard, and so on. However, the PET has a relatively low heat deformation temperature compared with conventional sheet forming materials, such as acryl (PMMA: Polymethyl Methacrylate) and polycarbonate (PC), and is not desirable for an outdoor use in which the temperature changes greatly. Therefore, to improve the heat resistance and the dimensional stability of the polyester resin, various researches have been carried out, and one of the representative methods thereof is the blending of PET and PC.

However, when blending PET and PC, the complex material does not have desirable properties in both of transparency and heat resistance. PET and PC are different from each other in melt viscosity and molecular structure. Thus, when simply mixing PET and PC, the main component forms a matrix, and the minor or blended component forms domains on the matrix. The sizes and refractive index of the domains depend on the degrees of the physical kneading and the chemical reaction between the two components, which results in the non-uniform and deteriorated transparency. Thus, generally, the conventional blend of PET and PC is not suitable for the production of transparent material, such as an optical instrument.

To improve the transparency, it is necessary to prevent the formation of the domains, or to reduce the size of the domains by adding an additive which works as a compatibilizer for PET and PC. Alternatively, the domains should be removing by inducing the chemical reaction between PET and PC. To accomplish these objects, various copolymers and various complex catalysts are developed. For example, U.S. Pat. No. 3,864,428 discloses a blend composition of polyester and PC, U.S. Pat. No. 4,879,355 discloses a method of introducing PET/bisphenol-A copolymer into a blend of PET and PC to improve transparency and heat resistance of the blend. And recently, U.S. Pat. No. 5,942,585 discloses the blend of PC and CHDM glycol-modified polyester. However, when more than a certain amount of PC is blended with PET, the transparency and heat resistance of the blend are not desirable. Thus, it is necessary to resolve these drawbacks.

### DISCLOSURE OF INVENTION

### Technical Problem

Therefore, it is an object of present invention to provide a blend of polyester and polycarbonate which overcomes the problem of the transparency deterioration of the conventional polyester/polycarbonate blend, and have superior heat resistance.

### Technical Solution

In order to achieve these objects, the present invention provides a blend of polyester and polycarbonate comprising: (a) polyethyleneterephthalate (PET) prepared with terephthalic acid component and ethylene glycol component, or copolymerized polyethyleneterephthalate prepared with terephthalic acid component and ethylene glycol component, and further copolymerized with 1 to 10 mol% of isophthalic acid, cyclohexane dimethanol (CHDM), diethylene glycol and/or alkylene glycol of 3 to 6 carbon atoms component with respect to acid or diol components; (b) polycarbonate (PC); and (c) CHDM modified PET prepared with 20 to 80 mol % CHDM with respect to diol components. The amount of the PC is 10 to 60 wt % with respect to the mixture of (a) PET and (b) PC, and the amount of the (c) CHDM modified PET is 0.2 to 2.5 times by weight with respect to the amount of (b) PC.

### Advantageous Effects

The polyester/polycarbonate blend of the present invention resolves the problem of the transparency deterioration of the conventional PET/PC blend which is designed to improve heat resistance. Therefore, the polyester/polycarbonate blend of the present invention uses PET as the main component, and can be easily and economically used to prepare a transparent article having superior heat resistance.

### MODE FOR THE INVENTION

A more complete appreciation of the invention, and many of the attendant advantages thereof, will be better appreciated by reference to the following detailed description.

When polycarbonate (PC) resin is blended with transparent polyester (PET) resin to improve the heat resistance of PET, if more than a certain amount of PC is blended with PET, the transparency of the blend is remarkably deteriorated. To resolve these drawbacks, the present invention provides a polyester/polycarbonate blend having optimum composition and component amounts.

Generally, in the case of injection molding, extrusion molding, or compounding the blend of PET and PC, when the amount of PC is less than 10 wt % (weight %) in the blend, the transparency deterioration is not serious. When the amount of PC is in the range of 10 to 20 wt % in the blend, the transparency is slightly deteriorated, but the blend is not opaque. However, when the amount of PC is more than 20 wt % in the blend, the light transmittance greatly decreases and the transparency is also greatly deteriorated. This is due to the PC domains having the size of several micro meter formed in PET. For preventing the abrupt decrease of the light transmittance, it is necessary to reduce the size or number of the PC domains. To control the PC domains as mentioned, it is necessary to improve the blend compatibility of PC and PET, or compensate or reduce the refractive index difference generated at the boundaries of the PC domain and the PET matrix. Thus, the present inventors have introduced various resins when blending PET and PC to improve the blend compatibility, or to compensate or reduce the refractive index difference, and found that both of the transparency and heat resistance can be improved by introducing glycol modified polyester prepared with 20 to 80 mol % of 1,4-cyclohexanedimethanol (hereinafter, CHDM) with respect to diol components into the blend of PET and PC.

The blend of polyester and polycarbonate of the present invention comprises: (a) polyethyleneterephthalate (PET) prepared with terephthalic acid component and ethylene glycol component, or copolymerized polyethyleneterephthalate prepared with terephthalic acid component and ethylene glycol component, and further copolymerized with 1 to 10 mol % of isophthalic acid, cyclohexanedimethanol (CHDM), diethylene glycol and/or alkylene glycol of 3 to 6 carbon atoms component with respect to acid or diol components; (b) polycarbonate (PC); and (c) CHDM modified PET prepared with 20 to 80 mol % CHDM with respect to diol components.

In the present invention, the main component, PET component, can be a conventional PET which is prepared with terephthalic acid component and ethylene glycol component. If necessary, the PET component can be a polyethyleneterephthalate modified with other component(s), for example, the PET component can be copolymerized with isophthalic acid, cyclohexanedimethanol (CHDM), diethylene glycol and/or alkylene glycol of 3 to 6 carbon atoms component(s). Preferably, when isophthalic acid component is copolymerized, the amount of isophthalic acid component is 1 to 10 mol % with respect to total acid components of the copolymerized PET. Preferably, when cyclohexanedimethanol (CHDM), diethylene glycol and/or alkylene glycol of 3 to 6 carbon atoms component is(are) copolymerized, the amount of the glycol component(s) is 1 to 10 mol % with respect to total diol components of the copolymerized PET.

As the (b) polycarbonate (PC) component, a conventional polycarbonate basically prepared with bisphenol-A as a main component can be used without specific limitations. The (b) polycarbonate (PC) component can be a conventional polycarbonate of injection molding and/or extrusion molding grade. The amount of the PC is 10 to 60 wt %, preferably 20 to 40 wt % with respect to the mixture of (a) PET and (b) PC. When the amount of PC is less than 10 wt %, the heat resistance is insufficiently improved. When the amount of PC is more than 60 wt %, the PET blending effect cannot be obtained and it is economically undesirable.

The amount of the (c) CHDM modified PET, which is added to improve the transparency of the blend, is 0.2 to 2.5 times, preferably 0.5 to 2 times by weight with respect to the amount of (b) PC. When the amount of the (c) CHDM modified PET is less than 0.2 times by weight with respect to the amount of (b) PC, the transparency is insufficiently improved. When the amount of the (c) CHDM modified PET is more than 2.5 times by weight with respect to the amount of (b) PC, the transparency is not further improved, but it is economically undesirable. Preferably, the (c) CHDM modified PET is prepared with CHDM and ethylene glycol as the diol components and terephthalic acid as the acid component. When the amount (mole) of ethylene glycol is more than that of CHDM in the diol components, the CHDM modified PET is PETG (CHDM-modified polyethylene terephthalate). When the amount (mole) of CHDM is more than that of ethylene glycol in the diol components, the CHDM modified PET is PCTG (glycol-modified poly(1,4-cyclohexylenedimethylene terephthalate). The amount of CHDM is 20 to 80 mol %, preferably 40 to 70 mol % with respect to the total diol components of the CHDM modified PET. When the amount of the CHDM is less than 20 mol %, the transparency is insufficiently improved. When the amount of the CHDM is more than 80 mol %, the transparency is not further improved, but it is economically undesirable.

As stated above, in case of molding the polyester/polycarbonate blend of the present invention, the molded transparent polyester blend has superior transparency and heat resistance with the haze value of less than 30% and the heat distortion temperature (HDT) of higher than 75° C. (the haze value and the HDT are measured for a sample of 3 mm thickness). Preferably, the heat distortion temperature (HDT) of the polyester/polycarbonate blend is higher than the glass transition temperature measured with Differential Scanning Calorimeter (DSC), wherein the scanning speed of DSC is 10° C./min at 30 to 200° C., and HDT measurement is carried out at 0.455 Mpa according to ASTM D648.

The polyester/polycarbonate blend of the present invention may be simply mixed, and then directly used for injection molding or extrusion molding, or may be mixed for compounding and extruded to form a pellet, and then the crystallized pellet can be used for injection molding or extrusion molding. Meanwhile, the polymer(s) used in the present invention may be produced in the presence of conventional organic or inorganic polymerization catalyst such as antimony based catalyst, cobalt based catalyst, germanium based catalyst, titanium based catalyst, calcium based catalyst, aluminum based catalyst, and so on.

Hereinafter, examples and comparative examples are provided to illustrate the present invention in more detail, but the present invention is not restricted or limited by the following examples and comparative examples.

### EXAMPLES 1

5 kg of PET (SKYPET, SK Chemicals Co., Ltd., copolymerized with isophthalic acid of 2.7 mol %, hereinafter, Component A) dried at 160° C. for 5 hours in a dehumidifying drier, 4 kg of PC (LGDOW polycarbonate Ltd., Melt Index (MI): 30, hereinafter, Component B) dried at 120° C. for 5 hours in the dehumidifying drier, and 1 kg of CHDM modified polyester (J2003, SK Chemicals Co., Ltd., CHDM content: 65 mol % with respect to diol components, hereinafter, Component C) dried at 80° C. for 6 hours in the dehumidifying drier were added into a dried bottle and fully mixed while tumbling for 3 minutes. The mixture was injection molded with a cold runner (water-cooling) type mold which can produce sample of 3 mm thickness/40 mm×40 mm size and sample of 3 mm thickness/120 mm×120 mm size. In the injection molding machine, L/D of a screw was 23, and a compression ratio was 3. For the injection molded samples, the transparency and the heat deformation temperature (HDT) were measured and listed in the following Table 1.

### EXAMPLES 2 TO 10

Except for changing the amounts of component A, component B, and component C as shown in the following Table 1, the samples were prepared according to the same manner of Example 1. For the injection molded samples, the transparency and the heat deformation temperature (HDT) were measured and listed in the following Table 1.

### COMPARATIVE EXAMPLE 1 TO 6 AND 8 TO 10

Except for using the amounts of component A and component B as shown in the following Table 1, and not using component C, the samples were prepared according to the same manner of Example 1. For the injection molded samples, the transparency and the heat deformation temperature (HDT) were measured and listed in the following Table 1.

### COMPARATIVE EXAMPLES 7

The mixture of 7 kg of component A and 3 kg of component B was prepared according to the same manner of Example 1, was extruded with a single screw extruder, and cut into pellets. In the extruder, the screw length was 500 mm and the compression ratio was 2.5. During the extrusion, 7 g of lanthanum catalyst was added as an additive for mixing PET and PC. The pellets were dried at 120° C. and were injection molded according to the same manner of Example 1 to produce samples. For the injection molded samples, the transparency and the heat deformation temperature (HDT) were measured and listed in the following Table 1.

TABLE 1

| | | | | | Amount of B in | Weight ratio of | |
|---|---|---|---|---|---|---|---|
| | Component | Component | Component | Haze | Blend (A + B) | Component C/ | HDT |
| | A (kg) | B (kg) | C (kg) | (%) | (wt %) | Component B | (° C.) |
| Example 1 | 5 | 4 | 1 | 35 | 44 | 0.25 | 114 |
| Example 2 | 5 | 3 | 2 | 7 | 38 | 0.67 | 102 |
| Example 3 | 6 | 3 | 1 | 25 | 33 | 0.33 | 102 |
| Example 4 | 7 | 2 | 1 | 9 | 22 | 0.50 | 79 |
| Example 5 | 6 | 2 | 2 | 4 | 25 | 1.0 | 95 |
| Example 6 | 5 | 2 | 3 | 4 | 29 | 1.5 | 98 |
| Example 7 | 5.5 | 2.5 | 2 | 5 | 31 | 0.80 | 100 |
| Example 8 | 4.5 | 1.8 | 3.7 | 4 | 29 | 2.05 | 98 |
| Example 9 | 4 | 3.6 | 2.4 | 6 | 47 | 0.67 | 105 |
| Example 10 | 8 | 1.5 | 0.5 | 17 | 16 | 0.33 | 76 |
| Comparative | 9 | 1 | 0 | 20 | 10 | 0 | 74 |
| Example 1 | | | | | | | |
| Comparative | 8 | 2 | 0 | 32 | 20 | 0 | 79 |
| Example 2 | | | | | | | |
| Comparative | 7 | 3 | 0 | 45 | 30 | 0 | 93 |
| Example 3 | | | | | | | |
| Comparative | 6 | 4 | 0 | 65 | 40 | 0 | 97 |
| Example 4 | | | | | | | |
| Comparative | 5 | 5 | 0 | 70 | 50 | 0 | 101 |
| Example 5 | | | | | | | |
| Comparative | 10 | 0 | 0 | 5 | 0 | 0 | 70 |
| Example 6 | | | | | | | |
| Comparative | 7 | 3 | 0 | 6 | 30 | 0 | 80 |
| Example 7 | | | | | | | |
| Comparative | 0 | 10 | 0 | 2 | 100 | 0 | 138 |
| Example 8 | | | | | | | |
| Comparative | 0 | 0 | 10 | 1.5 | — | 100 | 75 |
| Example 9 | | | | | | | |
| Comparative | 0 | 2 | 8 | 2 | 100 | 4.0 | 82 |
| Example 10 | | | | | | | |

As shown in Table 1, in comparative examples 3 to 5, the amount of component B is 30 to 50 wt % in the blend (A+B) and the haze value is higher to 45 to 75%. Meanwhile, in examples 1 to 3, the amount of component B is 33 to 44 wt % in the blend (A+B), but component C is added by 0.25 to 0.67 times by weight of component B, and the haze value decreases to 7 to 35%, which means that the transparency is improved. Especially, in example 2 in which component B is added by 38wt % and the component C is added by 0.67 times by weight of component B, the haze value is 7%, which means that the transparency is greatly improved. In addition, the heat distortion temperature is 102° C. which is higher than 97° C. of comparative example 4. Thus, the sample of Example 2 has the synergistic effect that the heat resistance as well as the transparency is improved. In Examples 5 and 6 in which the amount of component B is 20 wt % with respect to the total blend, the heat distortion temperatures are 95° C. and 98° C., respectively. The heat distortion temperatures of Examples 5 and 6 is higher by more than 10° C. than the heat distortion temperature (79° C.) of the comparative example 2 wherein the amount of component B is 20 wt % in the composition of only components A and B, and the heat distortion temperature (82° C.) of the comparative example 10 wherein the amount of component B is 20 wt % in the composition of only components B and C.

Transparency of Example 2 is almost same as that of comparative example 6 wherein only PET is injection molded and that of comparative example 7 wherein expensive lanthanum catalyst is used as an additive for melt-mixing PET and PC. However, in comparative example 7, the transparency is excellent, but the heat deformation temperature is 80° C., which is inferior in heat resistance to the sample of example 7 (heat deformation temperature: 100° C.). In examples 4 to 7 in which the amounts of component B are 22 to 31 wt %, and component C is added by 0.5 to 1.5 times by weight of component B, the transparency is remarkably improved to have the haze value of 4 to 9%. From the above stated results, when the CHDM modified polyester is used in the blending of PET and PC, it is clear that the transparency and the heat resistance are greatly improved.

1. A blend of polyester and polycarbonate comprising:
(a) polyethyleneterephthalate (PET) prepared with terephthalic acid component and ethylene glycol component, or copolymerized polyethyleneterephthalate prepared with terephthalic acid component and ethylene glycol component, and further copolymerized with 1 to 10 mol % of isophthalic acid, cyclohexane dimethanol (CHDM), diethylene glycol and/or alkylene glycol of 3 to 6 carbon atoms component with respect to acid or diol components;
(b) polycarbonate (PC); and
(c) CHDM modified PET prepared with 20 to 80 mol % CHDM with respect to diol components,
wherein the amount of the PC is 10 to 60 wt% with respect to the mixture of (a) PET and (b) PC, and the amount of the (c) CHDM modified PET is 0.2 to 2.5 times by weight with respect to the amount of (b) PC.

2. The blend of polyester and polycarbonate according to claim 1, wherein the amount of the PC is 20 to 40 wt % with respect to the mixture of (a) PET and (b) PC, and the amount of the (c) CHDM modified PET is 0.5 to 2 times by weight with respect to the amount of (b) PC, and the amount of CHDM is 40 to 70 mol % with respect to the total diol components of the CHDM modified PET.

3. The blend of polyester and polycarbonate according to claim 1, wherein the blend has the haze value of less than 30% and the heat distortion temperature (HDT) of higher than 75° C. when molded into a sample of 3 mm thickness.

4. The blend of polyester and polycarbonate according to claim 3, wherein the heat distortion temperature (HDT) of the blend is higher than a glass transition temperature measured with Differential Scanning Calorimeter (DSC).

5. The blend of polyester and polycarbonate according to claim 1, wherein the polymer used in the blend are produced in the presence of polymerization catalyst selected from the group consisting of antimony based catalyst, cobalt based catalyst, germanium based catalyst, titanium based catalyst, calcium based catalyst, and aluminum based catalyst.
